(19) United States
(12) Patent Application Publication
(10) Pub. No.: US 2008/0231446 A1
(43) Pub. Date: Sep. 25, 2008

(54) TRACKING AUTOMOTIVE VEHICLES IN A DEALER LOT

(76) Inventor: George A. CRESTO, Marietta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/688,940

(22) Filed: Mar. 21, 2007

(51) Int. Cl. G08B 13/22

(52) U.S. Cl. 340/572.1

(57) ABSTRACT

Automotive vehicles in dealer inventory are tracked using a radio-frequency identification (RFID) system, so that a vehicle can be located in real-time on a dealer lot. A centralized inventory tracking service can remotely monitor the vehicles at a number of dealerships, and dealer personnel can remotely access the tracking computer system via a Web-based user interface. Conventional vehicle inventory information can be periodically downloaded from a dealer inventory database to the tracking computer system. Various features of the invention take advantage of such integration of dealer inventory information with tracking information.

### BACKGROUND OF THE INVENTION

1. Field of the Invention

The present invention relates generally to tracking items using radio-frequency identification (RFID) systems and, more specifically, to tracking inventory in an automobile dealer lot.

2. Description of the Related Art

There has been great interest in using radio-frequency identification (RFID) technology to track, i.e., monitor the position and movement of, objects, including automobiles and other vehicles. In a typical tracking system, the object is equipped with or attached to a compact electronic device, commonly referred to as a “tag,” which contains active or passive transponder electronics. Other electronic devices that may be referred to as interrogators, readers or receivers are placed in locations where the objects are likely to pass or be stored. In one type of RFID technology, when the tag comes into close proximity with an interrogator, the interrogator causes the tag to broadcast an identification code that is uniquely associated with the tag. The interrogator can read the code, thereby identifying the tag and its associated object. The location of the object can be inferred from the location of the interrogator.

Another type of RFID technology is based upon the IEEE 802.1 wireless local area network (WLAN) standard. This technology is widely promoted by the Wi-Fi Alliance group, a trade organization, under the name Wi-Fi®, for use in wireless networking with devices such as laptop computers and consumer electronic devices. In accordance with the IEEE 802.1 standard, a compliant device can communicate with a radio transceiver known as an access point, which is in turn coupled to an Ethernet router or similar device. In a typical WLAN based upon this technology, a device can communicate with an access point from as far as several hundred meters away.

In the WLAN-based RFID system described in U.S. Patent Application Publication Nos. 2005/0207381 and 2005/0156711, an IEEE 802.1-compliant tag transmits an RF signal that is analogous to the signal transmitted by a wireless computing device for the purpose of establishing a network connection with an access node. Such a system is commercially available from AeroScout, Inc. of San Mateo, Calif. Specially adapted access nodes that are placed in locations where the objects to which the tags are attached are likely to pass or be stored can decode a unique identifier in the received signal, such as the tag's media access control (MAC) address. The locations of objects can be determined with substantial precision by triangulating among the signals received by several access nodes using methods such as Time-Difference of Arrival (TDOA) and Received Signal Strength Indication (RSSI).

RFID systems have been used to track vehicles. However, users may find such tracking systems inconvenient to use and difficult to reconcile with existing vehicle management systems and procedures to which they are accustomed. It would be desirable to provide a system and method for tracking vehicles that is convenient to use and enhances various vehicle management functions.

### SUMMARY OF THE INVENTION

The present invention relates to a system and method for tracking automotive vehicles in dealer inventory by monitoring tracking information received from a radio-frequency identification (RFID) system on a dealer lot. In an exemplary embodiment of the invention, a centralized inventory tracking service, which can be provided under a business agreement with a number of dealers, uses a tracking computer system located remotely from the dealers to monitor the vehicles at the various dealerships. Dealer personnel can remotely access the tracking computer system via a Web-based user interface. The user interface can display the locations of vehicles on a graphical map of the dealer lot, with icons representing the locations of vehicles. The RFID system can use wireless local area network (WLAN) technology, such as that specified in the well-known IEEE 802.1 standard, or any other suitable technology known to be usable for RFID purposes.

The tracking computer system downloads vehicle inventory information from a dealer inventory database, either in real-time in response to the addition of a vehicle to or removal of a vehicle from inventory or, alternatively, on a periodic basis, such as nightly. The tracking computer system can associate each of a number of RFID transponder tags with a vehicle in dealer inventory. Dealer personnel initiate the process of associating a transponder tag with a vehicle by selecting a tag and a vehicle, and indicating to the tracking computer system to associate them. The tag can then be placed in the vehicle where it is parked on the dealer lot.

The user interface can include a search feature for locating vehicles on the lot by various search criteria, such as Vehicle Identification Number (VIN), stock number, make, model, year, etc. The tracking computer system can also periodically issue alerts to dealership personnel (e.g., via e-mail, text message, etc.) to alert them of vehicles indicated as being in dealer inventory but not yet associated with a transponder tag, as well as of vehicles associated with a transponder tag but no longer indicated as being in dealer inventory. Another feature of the user interface that can be included in the exemplary embodiment of the invention provides an indication of the time elapsed since the location of a vehicle was last determined, so that users can assess the reliability or “freshness” of the location determination. Still other features are described below with regard to the detailed description of the exemplary embodiment.

### BRIEF DESCRIPTION OF THE DRAWINGS

FIG. 1 illustrates a system for tracking automotive vehicles in dealer inventory in accordance with an exemplary embodiment of the invention.

FIG. 2 illustrates an exemplary dealer lot having RFID receivers distributed about it to aid in tracking vehicles having RFID tags.

FIG. 3 is a flow diagram illustrating a method for tracking automotive vehicles in dealer inventor in accordance with the exemplary embodiment.

FIG. 4 illustrates a main-menu screen of a graphical user interface in accordance with the exemplary embodiment.

FIG. 5 illustrates an uploaded inventory list screen of the graphical user interface in accordance with the exemplary embodiment.

FIG. 6 illustrates an RFID tag assignment screen of the graphical user interface in accordance with the exemplary embodiment.

FIG. 7 illustrates an alert screen of the graphical user interface in accordance with the exemplary embodiment.

FIG. 8 illustrates another alert screen of the graphical user interface in accordance with the exemplary embodiment.

FIG. 9 illustrates a search screen of the graphical user interface in accordance with the exemplary embodiment.

FIG. 10 illustrates a vehicle information screen of the graphical user interface in accordance with the exemplary embodiment.

FIG. 11 is similar to FIG. 9, illustrating a scan-age search selection feature of the search screen.

FIG. 12 is similar to FIG. 9, illustrating a vehicle status search selection feature of the search screen.

### DETAILED DESCRIPTION

In the following description, like reference numerals indicate like components to enhance the understanding of the invention through the description of the drawings. Also, although specific features, configurations, arrangements and steps are discussed below, it should be understood that such specificity is for illustrative purposes only. A person skilled in the relevant art will recognize that other features, configurations, arrangements and steps are useful without departing from the spirit and scope of the invention. Unless specifically noted otherwise, the order in which method steps are described is for illustrative purposes only, and such steps can be arranged in any other suitable order or combined with each other or divided apart in any suitable manner.

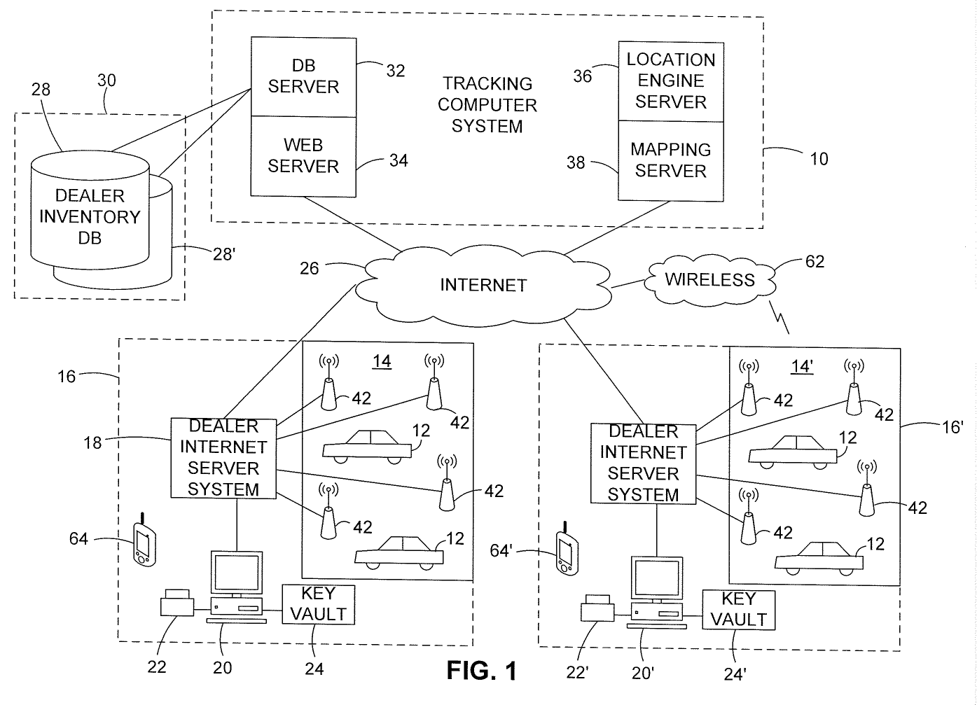

As illustrated in FIG. 1, in an exemplary embodiment of the invention, dealer personnel can use a tracking computer system 10 to track vehicles 12 (i.e., inventory) on dealer lots 14 equipped with a radio-frequency identification (RFID) system. The term “dealer” is used in this patent specification (“herein”) to refer to any business entity that maintains an inventory of vehicles for the purpose of selling, auctioning, repairing, transferring or otherwise “dealing” in automotive vehicles. The terms “vehicle” and “automotive vehicle” as used herein include within their scope all personal and commercial automobiles, trucks, buses, motorcycles, etc. The terms “lot” and “dealer lot” are used herein to refer collectively to all grounds or premises on which a dealer's vehicle inventory may be located.

In addition to lot 14, each of a plurality of dealers 16, 16′, etc. has an Internet-connected dealer server system 18 and one or more associated computers 20, printers 22 and other such computing and data communication devices (not shown for purposes of clarity) that are commonly included in networked business computer systems. Server system 18 and associated computers 20 can be those through which dealer personnel access inventory and other conventional business information in the conventional manner in addition to being the system through which they access features of the present invention. As described in further detail below, a principle of the present invention is the integration of vehicle location-tracking information with conventional dealer inventory information. In the exemplary embodiment of the invention, each dealer server system 18 is also coupled to an electronically-controlled key vault 24 that secures the keys to the vehicles on lot 14, as described in further detail below. As one function of dealer server system 18 is to couple a number of locally networked dealer computers 20 to the Internet 26, dealer server system 18 can comprise (not shown for purposes of clarity) a router or switch, a firewall, and any other equipment commonly included in networked business computer systems, such as a fileserver, mailserver, etc. Although it is referred to herein as dealer “server” system in the exemplary embodiment, its primary function with regard to the present invention is to allow users of computers 20 (i.e., dealer personnel) to remotely access features of the invention via Internet 26, using a Web-based user interface, as described in further detail below.

As noted above, dealer personnel can access conventional inventory information by using computers 20 to access a dealer inventory database 28. In some conventional arrangements, such a database is managed by a party 30 other than dealer 16, through a contractual business arrangement. The other party maintains the computer system and associated data storage devices on which the information is stored and provides a user interface so that dealer 16 can remotely access the information via Internet 26. As indicated by the dashed line in FIG. 1 between Internet 26 and dealer inventory database 28, the information can be accessed by dealer personnel in such a conventional manner in addition to it being accessed through features of the present invention as described below. Note that for each dealer 16,16′, etc. there is shown a corresponding dealer inventory database 28, 28′, etc., to illustrate that party 30 may manage inventory information for a number of dealers 16. Although shown for purposes of illustration as located remotely from dealer 16 and managed by another party 30, arrangements are also known in which such a dealer inventory database is located at the premises of dealer 16 or is otherwise managed by dealer 16. Regardless of the arrangement, tracking computer system 10 can access dealer inventory databases 28 via a suitable data network. The network can include elements of Internet 26 or, as shown in FIG. 1 for purposes of illustration, a separate network.

Tracking computer system 10 can be operated by a third party to provide the vehicle tracking and related services described below to dealers 16 under a contractual arrangement with each dealer 16. In accordance with one exemplary business method, the third party charges each dealer a price for tracking a predetermined number of vehicles per month or on some other suitable per-vehicle basis.

Although the above-referenced third party can operate tracking computer system 10 in the exemplary embodiment to provide the services or features described below, portions of tracking computer system 10 may be disposed at different locations or in the possession or control of still other parties. For example, a database server 32 and user interface webserver 34 can be disposed at a first data center under the control of the party that provides the tracking and related services to a dealer 16, while a location engine server 36 and a mapping server 38 may be disposed a second data center under the control of another party. In other embodiments, however, these elements of tracking computer system 16 can be disposed in any suitable location and operated by any suitable party or parties. They can be integrated with each other to an extent greater than that indicated in the illustrated embodiment or, alternatively, divided into sub-elements to define an even more distributed computing arrangement.

In the exemplary embodiment, location engine server 36 and mapping server 38 can comprise one or more server computers on which are installed the AeroScout Engine™ and AeroScout MobileView™ software products, respectively, available from AeroScout, Inc. of San Mateo, Calif. Accordingly, location engine server 36 can perform the functions of receiving IEEE 802.1-compliant WLAN signals transmitted by RFID tags (not separately shown in FIG. 1 for purposes of clarity) installed in vehicles 12 and using those signals to determine the RFID tag locations in real-time. The tags are likewise commercially available from AeroScout. In addition, mapping server 38 interfaces with location engine server 36 to transform the determined RFID tag locations into a format that can be integrated with third-party software applications to provide Web-based graphical user interfaces for viewing object positions on a map in real-time.

Database server 32 performs the function of downloading dealer inventory information from dealer inventory database 28, as described in further detail below. It interfaces with user interface webserver 34, which provides a Web-based user interface through which remote users (e.g., users of computers 20) interact with tracking computer system 10 in the manner described below. Note that, as “servers” (i.e., computer systems), all of the above-described elements of tracking computer system 10 comprise various processors, memory and other hardware and software elements (not shown for purposes of clarity) that, when suitably programmed or configured with software, effect the methods described below, and that their memories, disks or other computer-readable data storage media in which such software resides constitute a “computer program product” as that term is used in patent claims.

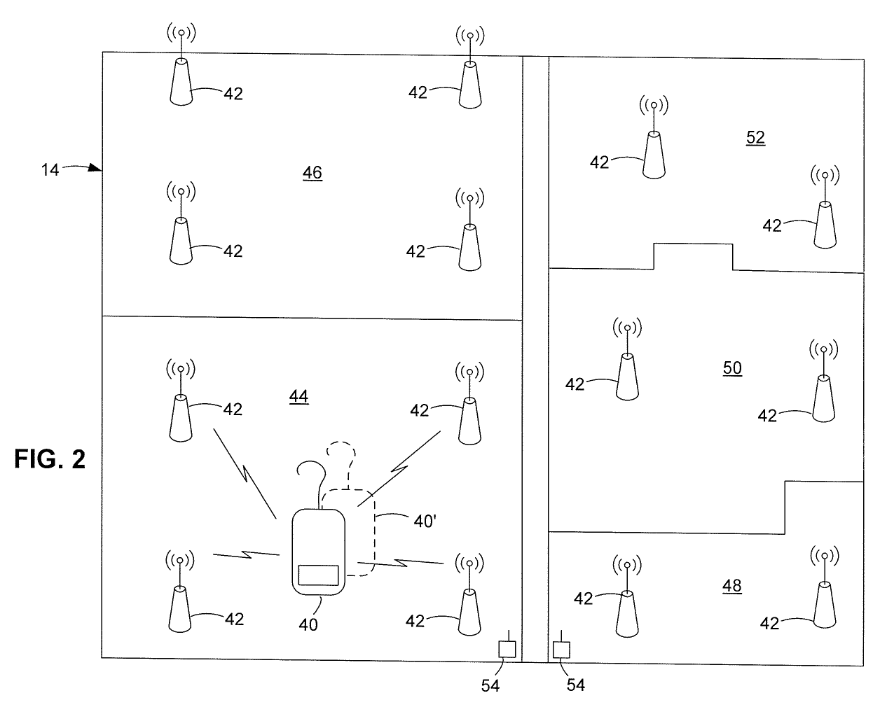

As illustrated in FIG. 2, in addition to tracking computer system 10, the system comprises a number of RFID tags 40. A suitable type of RFID tag 40 is also commercially available from AeroScout, Inc. After associating a tag 40 with a vehicle 12 (FIG. 1) in the manner described below, dealer personnel can place tag 40 in vehicle 12 by, for example, hanging it by a hook portion from the vehicle rear-view mirror. When placed in vehicle 12, each tag 40 can communicate with one or more specially adapted WLAN access points, referred to herein as receivers 42, which have been distributed about dealer lot 14. Suitable receivers 42 are also available from AeroScout, Inc. Specifically, location engine server 36 (FIG. 1) can determine the location and identity of each tag 40 in response to signals received by receivers 42. Receivers 42 are further equipped with solar panels so that their power supply circuits need not rely upon batteries or power cables (though batteries can be included and kept charged from solar-generated power). Note that receivers 42 communicate data with location engine server 36 via the firewall, Internet switch, or other relevant elements of dealer server system 18. For security purposes, data communication between dealer server system 18 and location engine server 36 (via Internet 26) can be via a virtual private network (VPN). Although receivers 42 are illustrated for purposes of clarity in FIG. 1 as directly connected to dealer server system 18, any suitable intermediate devices can be included between them, such as wireless backhaul nodes (not shown) that couple distant receivers 42 or groups of receivers 42 to dealer server system 18. Such devices can similarly be solar powered.

Additional, secondary tags 40′ that may not be associated with a vehicle can be detected and their location and identity determined in the same manner. Such secondary tags can be associated with, for example, dealer salespersons or other personnel who carry the tags on their persons. Location engine server 36 can thus be used to determine not only the location of a vehicle 12 on lot 14 but also the location of dealer personnel, thereby enabling it to be determined which salesperson is currently with which vehicle 12.

Note that the exemplary arrangement of lot 14 as illustrated in FIG. 2 is representative of a typical dealer lot in that it comprises a number of regions or areas in which vehicles may be located, such as a main lot 44, a back lot 46, a front lot 48, a showroom and service facility 50, and a vehicle inspection lot 52. Note that receivers 42 are distributed as necessary throughout these areas to enable location tracking throughout lot 14. In addition, similar devices known as exciters 54 can be disposed adjacent driveways or other chokepoints where it is especially desirable to monitor the passage of vehicles 12. For example, one or more exciters 54 can be disposed adjacent the entrance/exit to lot 14 to enable identification of the vehicles 12 (and salespersons in them) who enter and exit lot 14 on test drives with customers or for other purposes. Although exciters 54 and receivers 42 are described as separate devices in the exemplary embodiment for purposes of illustration, in other embodiments they can be the same type of device.

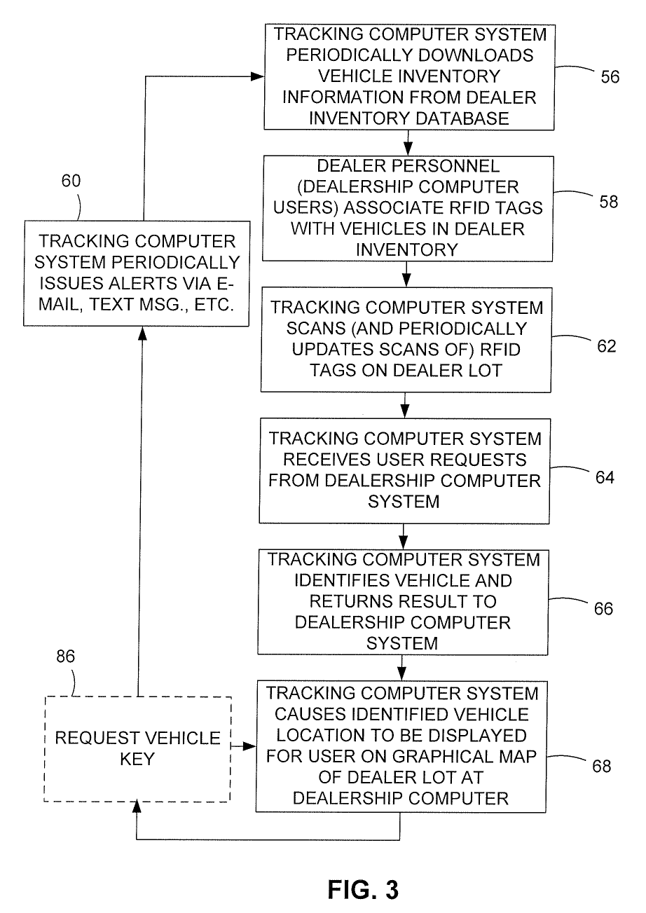

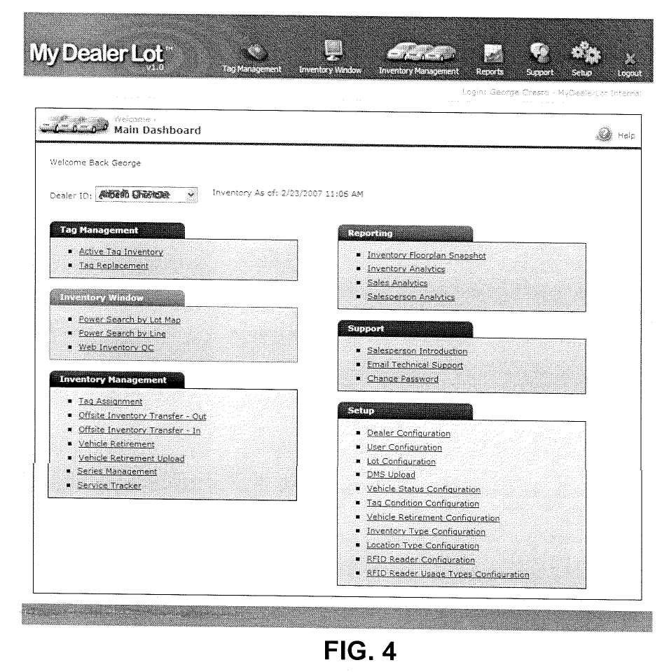

An overview of an exemplary vehicle tracking method is illustrated in FIG. 3. Note that the illustrated steps and the order in which they are shown are intended only to be exemplary, and that the steps can be performed in accordance with a suitable graphical user interface, such as that represented by the exemplary display screens of FIGS. 4-12. As described above with regard to FIG. 1, the method is effected primarily through the operation of tracking computer system 10. In view of the descriptions herein, persons skilled in the art to which the invention relates will readily be capable of creating, obtaining or otherwise providing suitable software and otherwise programming or configuring the above-described elements of tracking system 10 to effect the method.

In operation, tracking system 10 provides a Web-based graphical user interface, accessible to dealer personnel via computers 20. That is, by logging in to a Web site provided by tracking system 10 (through its user interface webserver 34), a user can interact with tracking system 10. In response to the user entering a user name and password in a login procedure, tracking system 10 presents the main menu screen of FIG. 4 to the user on computer 20. As noted above, for security purposes, data communication between dealer server system 18 and tracking computer system 10 (via Internet 26) can be via a VPN. Data encryption can also be used. The main menu presents various options from which the user can select to cause tracking computer system to perform various corresponding actions, some of which are described below in further detail to illustrate features of the invention. (In accordance with graphical user interface conventions, a user can select a displayed item by clicking on it with a mouse.) Although tracking system 1 0 performs some actions in response to user input, it also performs others on a periodic basis or otherwise automatically. For example, referring again to FIG. 3, tracking computer system 10 periodically (e.g., nightly, after dealership business hours) downloads vehicle inventory information from dealer inventory database 28, as indicated by step 56.

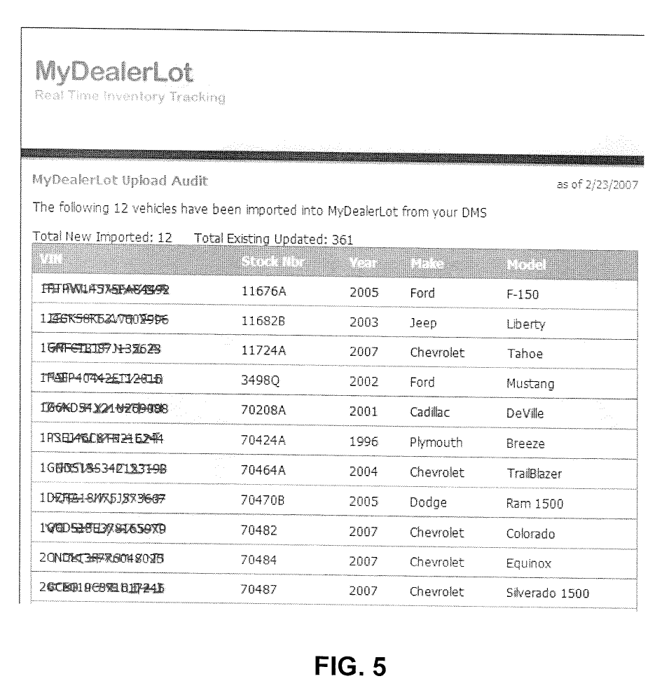

One of the options from which a user can select via the main menu is to view the downloaded inventory information. As illustrated in FIG. 5, in response to the user selecting this option, tracking computer system 10 presents a screen that lists vehicles in dealer inventory by Vehicle Identification Number (VIN), dealer stock number, year, make and model. This screen is similar to that which a dealer can conventionally obtain using its conventional dealer management system (DMS) (not shown), which can comprise a client-server information system involving dealer inventory database 28 and dealer server system 18 or other such computer system elements. The present invention can be provided in addition to or as a complement to such a conventional DMS or, alternatively, in place of a conventional DMS. Note that the screen of FIG. 5 indicates that inventory information relating to 12 vehicles has been imported into the system (referred to by the MyDealerLot™ product name) in this example. In an embodiment in which downloads occur nightly, this screen thus indicates that dealer 16 has received or otherwise incorporated into its inventory 12 additional vehicles during the previous day. (In alternative embodiments in which downloads occur in real-time in response to the addition of a vehicle to or removal of a vehicle from inventory, an updated screen would be available for viewing each time a vehicle is added to or removed from inventory.) When dealer 16 has received these vehicles, personnel park them in suitable locations in lot 14 (see FIG. 2). A large dealership in the United States can have as many as several thousand vehicles in inventory, and lot 14 can be spread across a vast area. The invention can enable a dealer to pinpoint the location (in some cases, to single parking-space resolution) of any of these vehicles at any time. For example, a customer may ask a salesperson if the dealership has a certain type of vehicle in inventory because the customer would like to test drive it. Using the system as described below, the salesperson can quickly determine the location of such a vehicle and take the customer to it or retrieve the vehicle for the customer.

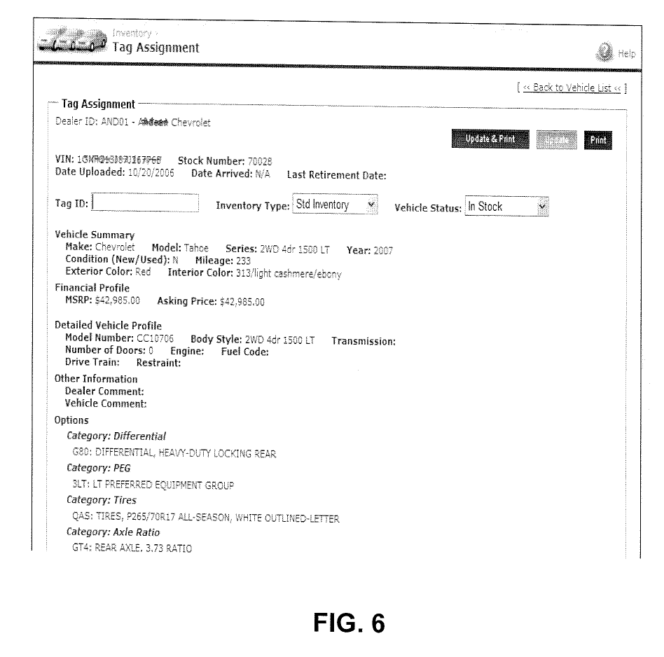

Another of the options from which a user can select via the main menu is to associate an RFID tag 40 (FIG. 2) with one of the vehicles for which inventory information has been downloaded, as indicated by step 58 (FIG. 3). The user can retrieve any unused tag 40, i.e., that is not currently associated with any vehicle, for this purpose, and dealer 16 may maintain a stockpile of such tags 40 to use when additional vehicles are received. In response to the user selecting this option, tracking computer system 10 presents a screen listing the vehicles for which inventory information has been downloaded but which have not yet been associated with a tag 40. The screen can be similar to that of FIG. 5. Indeed, it is contemplated that dealer 16 will generally cause this step to be performed at the time new vehicles are added to inventory. In response to the user selecting one of the listed vehicles, tracking computer 10 presents a screen, illustrated in FIG. 6, which prompts the user to enter a device identification number (“Tag ID”). The Tag ID can be any number, alphanumeric string, etc. that uniquely identifies tag 40. For example, as tag 40 is, in effect, a WLAN-compliant client device (i.e., Ethernet device) in the exemplary embodiment of the invention, it inherently has an associated media access control (MAC) address. The MAC address can be used as the Tag ID. The Tag ID may also be printed in human-readable form on tag 40, in which case the user can read it and type it in where prompted. Alternatively, or in addition, the Tag ID may be bar-coded or otherwise electronically readable, in which case the user can use a barcode scanner (not shown) or other such reader device, connected to computer 20, to cause the Tag ID to be read and entered. The tag 40 is then placed in the vehicle.

As indicated by step 60, which an be performed at any suitable time, tracking computer system 10 can cause various types of alert messages to be transmitted by various means to interested parties. For example, the alert message can be transmitted via e-mail, text message (via a conventional wireless telecommunications network 62 (FIG. 1)) or other suitable means. Dealer personnel can receive such alert messages on computers 20 or on their cellular telephones or other wireless mobile communication devices 64 (FIG. 1). Indeed, they can use wireless mobile communication devices 64 in the same manner as computers 20, to perform all of the same functions described herein as being performed from computers 20. Note that wireless mobile communication devices 64 can communicate not only via network 62 (e.g., a cellular telecommunications network) but also via a WLAN or, alternatively, a wireless personal-area network (WPAN) associated with computers 20 or dealer server system 18.

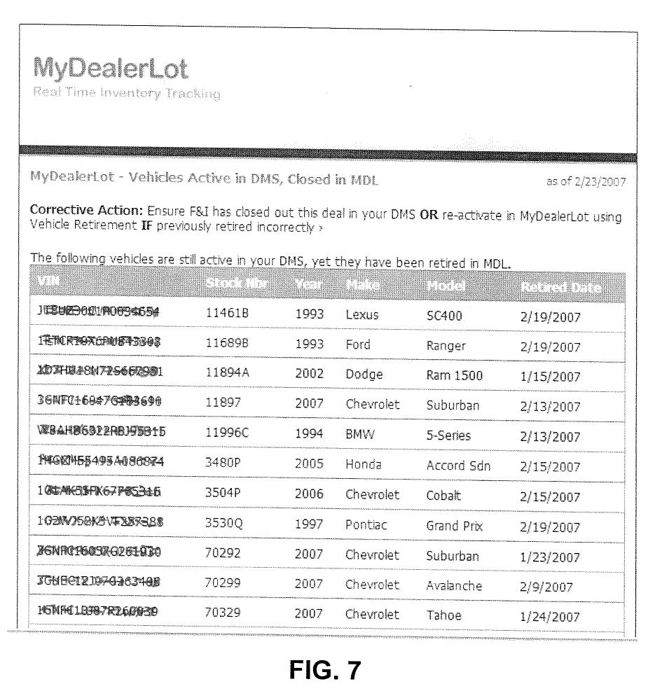

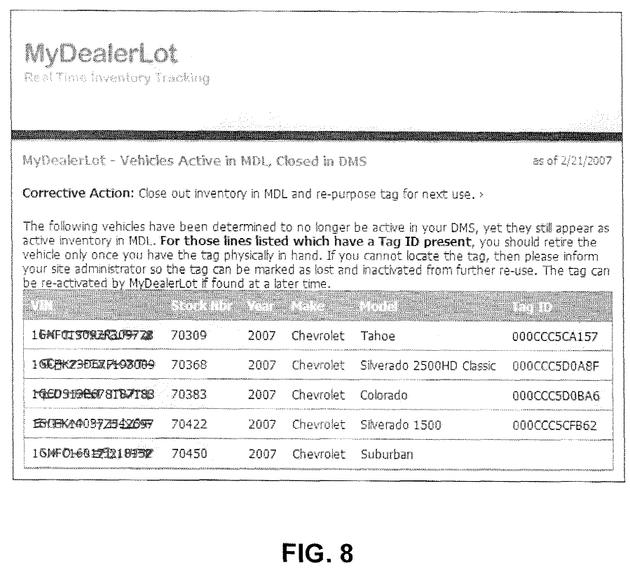

As illustrated in FIG. 7, an alert message can comprise a list of vehicles for which inventory information has been downloaded but to which no tag 40 has yet been assigned. Such a situation can arise if a vehicle is sold but the vehicle was inadvertently not removed from inventory records (using the conventional dealer management system). Conversely, as illustrated in FIG. 8, an alert message can comprise a list of vehicles with which a tag 40 has been associated (as described above with regard to step 58) but for which no downloaded inventory information exists. Such a situation can arise if, for example, the vehicle has been sold but the tag 40 was lost before it could be de-associated. Note that another main menu another option allows a user to de-associate or retire a tag when a vehicle is sold.

As indicated by step 62 (FIG. 3), tracking computer system 10 periodically scans tags 40 in lot 14 (i.e., processes the signals it receives signals from them) and uses the information to determine the locations and identities of the tags 40. Tracking computer system 10 then uses the locations and identities of the tags 40 to update its records of the locations of the associated vehicles. Depending upon how the system is configured in various embodiments of the invention, the number of tags 40 in lot 14 that need to be scanned, and whether a given tag 40 may be out of range of receivers 42 (e.g., the vehicle is out of lot 14 on a test drive), a given tag 40 may be scanned at intervals from once every few minutes to once every few hours or even less frequently.

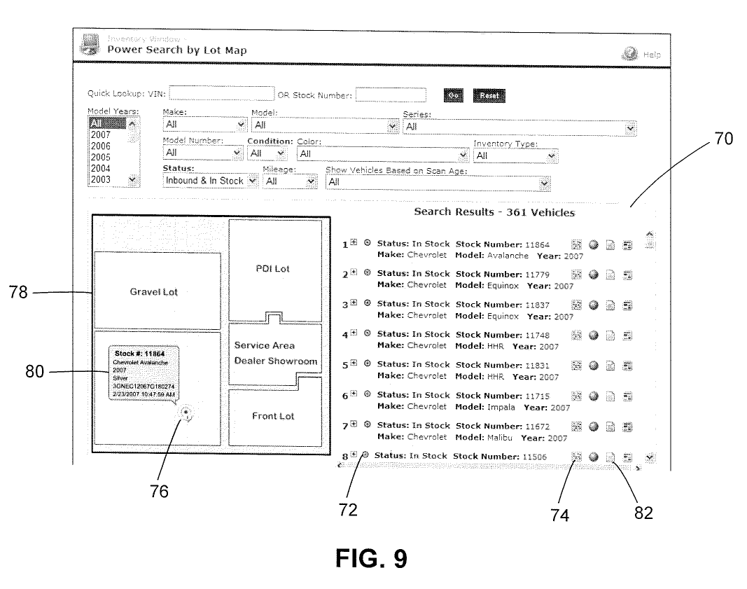

Another of the options from which a user can select via the main menu is to search for a vehicle or request other information from tracking computer system 10, as indicated by step 64 (FIG. 3). In response to the user selecting this option, tracking computer system 10 presents a screen, illustrated in FIG. 9, which prompts a user to enter as search criteria one or more vehicle attributes, such as VIN, make, model, year, stock number, color, mileage, condition and status. As indicated by step 66, tracking computer system 10 searches its database of downloaded vehicle inventory information for one or more vehicles having attributes that match the search criteria. As indicated by step 68, tracking computer system 10 causes the information relating to the vehicles found in the search to be listed on the screen in a results area 70. Along with this information, tracking computer system 10 may also return location information for the vehicles found in the search, though it may not cause the information to be displayed on the screen until the user selects a vehicle. Note that the default setting for the various selection boxes with which the user can select search criteria (i.e., vehicle attributes) is “All”. Thus, the default action is for tracking computer system 10 to list all vehicles that it can determine have been associated with a tag 40.

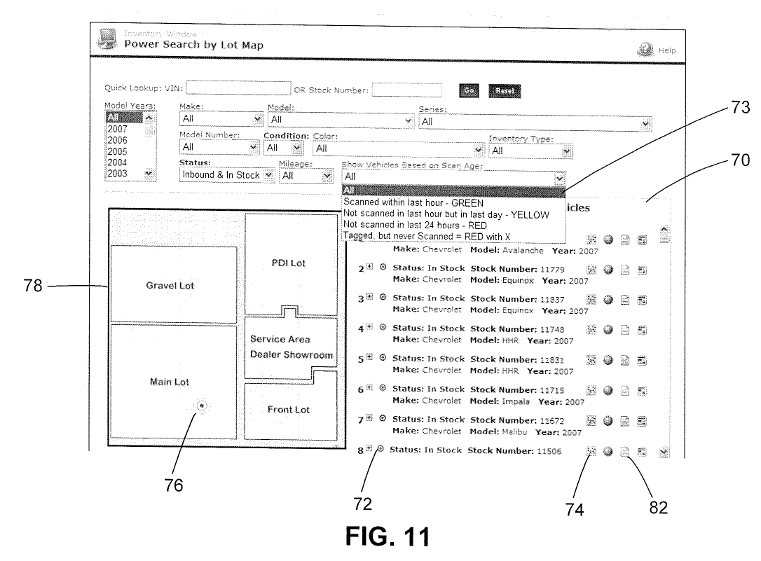

For each vehicle listed in results area 70, a number of associated items are displayed in addition to information relating to the above-described vehicle attributes. For example, an indicator 72 indicates the scan age for the corresponding vehicle, i.e., how long it has been since its associated tag 40 was successfully scanned. Indicator 72 can be color-coded to indicate scan age, such as green to indicate the tag 40 was successfully scanned within the last hour, yellow to indicate it was scanned more than one hour ago but less than one day ago, red to indicate it was scanned more than one day ago, etc. Referring briefly to FIG. 11, note the scan age search criteria selector box 73 that allows a user to search for vehicles based upon a selected scan age.

Other associated items that can be listed in results area 70 for a vehicle found in the search can include a map icon 74 on which a user can click. In response to a user selecting map icon 74, tracking computer system 10 displays a vehicle icon 76 representing the location of the corresponding vehicle on a graphical map 78. Map 78 resembles lot 14 (FIG. 2) and can be pre-stored in tracking computer system 10 as a preliminary step at the time the system is set up for the dealer. If the search results consist of only a single vehicle, e.g., the search criteria consisted of the vehicle's VIN or stock number, then tracking computer system 10 displays a vehicle icon 76 indicating the vehicle's location without the user having to click on map icon 74.

An informational callout box 80 is displayed in a manner suggesting its association with vehicle icon 76, either at the time that vehicle icon 76 is displayed or, alternatively, in response to a user clicking on vehicle icon 76. Callout box 80 conveniently lists various vehicle attributes so that the user can readily identify the vehicle without having to cross-reference it with the list in results area 70. As understood in the art, “callout box” refers to any bounded graphical region, as the term “box” is generally used to refer to any graphical region that performs some GUI function and is not limited to rectangular or “box”-shaped.

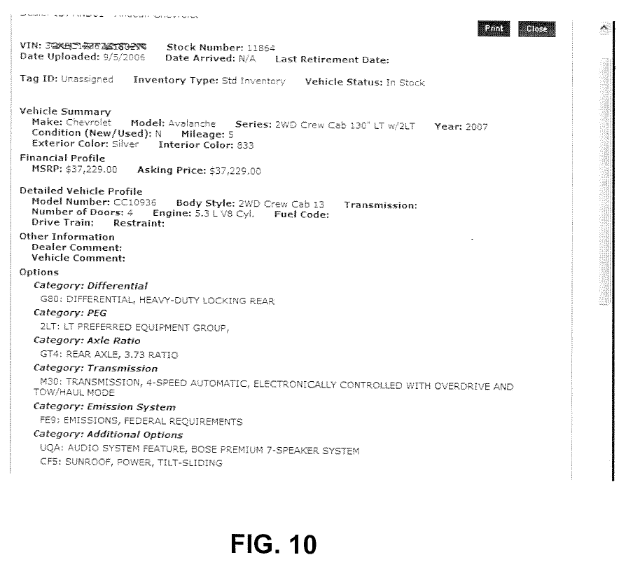

Another icon 82 displayed in results area 70 relates to displaying more detailed information about the corresponding vehicle. Selecting icon 82 causes tracking computer system 10 to display a screen such as that of FIG. 10.

Another alert that tracking computer system 10 can issue (step 60) relates to vehicle movement. The tags 40 that are commercially available from AeroScout, Inc. include motion sensors that detect when the tag 40 is disturbed. Tracking computer system 10 responds to activation of a motion sensor by transmitting a vehicle movement alert message in the manner described above with regard to step 60. Alternatively, or in addition, after tracking computer system 10 has determined the location of vehicle, it can issue an alert if the location changes from one scan to the next. Although not shown for purposes of clarity, a user can set filter criteria so that vehicle movement alerts are only issued based upon movement that occurs at certain times of day, etc.

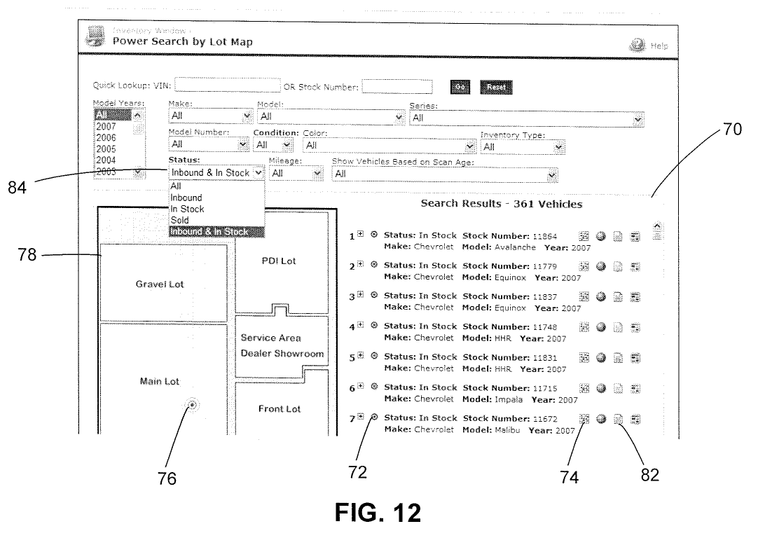

As illustrated in FIG. 12, another selector box 84 allows the user to search for vehicles based upon inventory status. Dealers commonly use the term “status” in the context of inventory to refer to whether a vehicle: is actually in stock, i.e., has been received and is in lot 14; has been sold but remains temporarily in lot 14; is inbound, i.e., has been added to inventory records but has not actually been placed in lot 14; etc.

Referring again to FIG. 3, whenever a person requests a key from key vault system 24 (FIG. 1), the request causes key vault system 24 to not only release the key in the conventional manner but also to request vehicle location information from tracking computer system 10 and display the location of the vehicle 12 for which the key was requested. In accordance with the invention, tracking computer system 10 electronically interfaces with key vault system 24 via computer 20 or dealer server system 18. Key vault system 24 can comprise any suitable device, such as one along the lines of those commercially available from KEYper Systems of Harrisburg, N.C. Automobile dealers conventionally use such vaults as stand-alone devices to secure and track the keys to their inventory. For example, when an employee wishes to use a vehicle (e.g., to take a customer for a test drive), he authenticates his identity to the key vault and identifies the vehicle. In response, the key vault releases a locking mechanism securing the selected key and creates an electronic record identifying the person to whom it released the key. In some vault types, each key is individually retained in a secure manner by a corresponding electromechanical mechanism, such as a drawer or panel. For example, in a drawer-based vault, one of a number of drawers slides open, exposing the requested key. In the KEYper® vault, for example, each key is secured in a tamper-proof manner to a plug, and the plugs are individually locked into corresponding ports (i.e., electromechanical mechanisms) on a panel. When the person returns the key, a corresponding record is created. Key vault system 24 includes not only the electromechanical locking mechanisms but also a computer-based key tracking system, including an integrated display (not shown) on which users can view the status of each key (e.g., that a key is checked out to a certain employee).

Interfaced with key vault system 24 in the novel manner described herein, tracking computer system 10 responds to a key request indication received (via Internet 26) from key vault system 24 by providing the location of the corresponding vehicle on lot 14. Key vault system 24 causes the location to be displayed in a window (not shown) on its integrated display in a graphical map format that is preferably essentially the same as that of graphical map 78 in FIG. 9. In other words, when a person requests a key from key vault system 24, it not only releases the key but also causes a window to appear on its display that informs the person of the location of the corresponding vehicle. In addition, tracking computer system 10 can respond to a key event (i.e., check-out of a key out to an identified employee or check-in of a key returned by an identified employee) by recording an indication of the event so that it can provide an key status indication via the user interface (e.g., the screen of FIG. 9). For example, it can cause an indicator (not shown) similar to indicator 72 to be displayed that identifies the status of the key. The indicator can comprise icons, text or other suitable indicia to indicate whether the key is in the vault or identify a person to whom the key is checked out.

In the manner described above, the present invention allows users to remotely track vehicles in a dealer lot. The invention is easy to use with minimal training, as it integrates the RFID tracking function with conventional dealer management system functions and inventory information with which such users are familiar.

It will be apparent to those skilled in the art that various modifications and variations can be made to this invention without departing from the spirit or scope of the invention. Thus, it is intended that the present invention covers the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A method for tracking automotive vehicles in dealer inventory, comprising:
associating each of a plurality of transponder tags with each of a corresponding plurality of vehicles in dealer inventory;
determining a location in the dealer lot of a vehicle with which a transponder tag is associated in response to a radio-frequency (RF) signal received from the transponder tag by a plurality of receivers disposed in a dealer lot; and
displaying the determined location of the vehicle in relation to a graphical representation of the dealer lot on a computer-based system having a graphical user interface, thereby indicating the location of the vehicle in the dealer lot.

2. The method claimed in claim 1, wherein the step of displaying the determined location of the vehicle comprises:
receiving a user selection of one or more vehicle attributes;
searching a database for vehicles in dealer inventory matching the selected attributes;
displaying on a graphical map representing the dealer lot a graphical icon representing the location of each vehicle in dealer inventory matching the selected attributes.

3. The method claimed in claim 2, wherein the step of receiving a user selection of one or more vehicle attributes comprises inputting an attribute selected from the group: vehicle identification number (VIN), inventory stock number, vehicle manufacturer name, vehicle model name, vehicle series, vehicle year, vehicle color, vehicle status, and vehicle mileage.

4. The method claimed in claim 1, wherein the step of displaying the determined location of the vehicle comprises:
displaying a list of vehicles in dealer inventory;
inputting a user selection of a vehicle in the list;
displaying a graphical map representing the dealer lot; and
displaying on the graphical map representing the dealer lot a graphical icon representing the location of the vehicle.

5. The method claimed in claim 4, further comprising:
receiving a user selection of the graphical icon representing the location of the vehicle; and
in response to the user selection of the graphical icon representing the location of the vehicle, displaying a graphical callout box in association with the graphical icon, the callout box including a description of vehicle attributes.

6. The method claimed in claim 4, wherein the step of displaying a list of vehicles in dealer inventory comprises displaying, for each of a plurality of vehicles in dealer inventory:
a textual description of one or more vehicle attributes; and
an indication of time elapsed since last performing the step of determining the location of the vehicle.

7. The method claimed in claim 1, wherein the step of associating a transponder tag with each of a plurality of vehicles in dealer inventory comprises:
selecting a vehicle having an associated vehicle identifier; and
storing in a computer database an association between the vehicle identifier and a device identification number uniquely identifying the transponder tag.

8. The method claimed in claim 7, wherein the vehicle identifier is a Vehicle Identification Number (VIN).

9. The method claimed in claim 7, wherein the vehicle identifier is a repair order number.

10. The method claimed in claim 7, wherein the step of selecting a vehicle comprises:
displaying a list of vehicles in dealer inventory; and
receiving a user selection of a vehicle in the list.

11. The method claimed in claim 7, wherein the step of associating a transponder tag with each of a plurality of vehicles in dealer inventory further comprises:
printing a label bearing indicia identifying a selected vehicle; and
affixing the label to the transponder tag to be associated with the selected vehicle.

12. A method for tracking automotive vehicles in dealer inventory, comprising:
a tracking computer system periodically downloading vehicle inventory information from each of a plurality of dealer inventory databases associated with automotive dealerships in accordance with a business agreement between each dealership and a party operating the tracking computer system;
the tracking computer system receiving tracking information from a radio-frequency identification (RFID) system disposed in a dealer lot of each dealership; and
the tracking computer system providing a graphical user interface remotely accessible from dealerships for identifying locations of vehicles in dealer lots in response to the tracking information.

13. The method claimed in claim 12, further comprising the step of the tracking computer system periodically outputting an alert identifying vehicles that are present in a dealer inventory database but have not been associated with a transponder tag of the RFID system.

14. The method claimed in claim 12, further comprising the step of the tracking computer system outputting an alert identifying vehicles that have been associated with a transponder tag of the RFID system but are not correspondingly present in a dealer inventory database.

15. The method claimed in claim 12, further comprising the step of the tracking computer system outputting an alert identifying vehicles that have changed locations.

16. The method claimed in claim 12, further comprising:
repeating the step of the tracking computer system receiving tracking information at predetermined time intervals for a vehicle; and
compiling a history comprising a plurality of locations of the vehicle in a dealer lot over a plurality of time intervals in response to the tracking information.

17. The method claimed in claim 12, wherein the party operating the tracking computer system charges a dealership on a per-vehicle basis for tracking vehicles under the business agreement.

18. The method claimed in claim 12, wherein the tracking computer system provides a Web-based user interface remotely accessible via the Internet.

19. A method for tracking automotive vehicles in dealer inventory, comprising:
associating a vehicle transponder tag with a vehicle;
associating a secondary transponder tag with the vehicle; and
determining a location in a dealer lot in response to first radio-frequency (RF) signals received from the vehicle transponder tag and second RF signals received from the secondary transponder tag by a plurality of receivers disposed in the dealer lot.

20. The method claimed in claim 19, wherein the step of determining a location comprises displaying the location in relation to a graphical map representing the dealer lot.

21. The method claimed in claim 19, wherein the secondary transponder tag is associated with a dealer employee.

22. The method claimed in claim 19, further comprising:
repeating the step of determining a location at predetermined time intervals; and
compiling a history comprising a plurality of locations determined over a plurality of time intervals.

23. A system for tracking automotive vehicles in dealer inventory, comprising:
a plurality of transponder tags, each tag attachable to one of a corresponding plurality of vehicles in dealer inventory; and
a tracking computer system having a communications interface for communicating data via a data network with one or more dealer inventory databases and with one or more radio-frequency identification (RFID) systems disposed in each of a plurality of dealer lots, the tracking computer system determining locations of vehicles in the dealer lots in response to tracking information received from the RFID systems and providing a graphical user interface remotely accessible from dealerships for identifying the determined locations of vehicles in the dealer lots.

24. The system claimed in claim 23, wherein an RFID system comprises a plurality of receivers for receiving RF signals from transponder tags, each receiver having a power supply circuit with a solar power source.

25. The system claimed in claim 23, wherein the user interface is a Web-based user interface remotely accessible via the Internet.

26. The system claimed in claim 23, wherein the tracking computer system downloads vehicle inventory information from each of a plurality of dealer inventory databases associated with automotive dealerships in accordance with a business agreement between each dealership and a party operating the tracking computer system.

27. The system claimed in claim 23, wherein the user interface displays the determined location of a vehicle in relation to a graphical representation of a dealer lot, thereby indicating the location of the vehicle in the dealer lot.

28. The system claimed in claim 23, further comprising an electronically-controlled key vault coupled in data communication with the tracking computer system, wherein the key vault releases a key corresponding to a vehicle and concurrently displays the determined location of the vehicle in relation to a graphical representation of the dealer lot.

29. The system claimed in claim 23, wherein the tracking computer system sends alerts via the data network in response to the tracking information.

30. The system claimed in claim 29, wherein the tracking computer system outputs an alert identifying vehicles that are present in a dealer inventory database but that have not been associated with a transponder tag of the RFID system.

31. The system claimed in claim 29, wherein the tracking computer system outputs an alert identifying vehicles that have been associated with a transponder tag of the RFID system but are not correspondingly present in a dealer inventory database.

32. The system claimed in claim 29, wherein the tracking computer system outputs an alert identifying vehicles that have changed locations.

33. A computer program product for tracking automotive vehicles in dealer inventory, the computer program product comprising computer-readable media having recorded thereon instructions for, when executed on a computer system, causing the computer system to:
associate each of a plurality of transponder tags with each of a corresponding plurality of vehicles in dealer inventory;
determine a location in the dealer lot of a vehicle with which a transponder tag is associated in response to a radio-frequency (RF) signal received from the transponder tag by a plurality of receivers disposed in the dealer lot; and
display the determined location of the vehicle in relation to a graphical representation of the dealer lot, thereby indicating the location of the vehicle in the dealer lot.

34. The computer program product claimed in claim 33, wherein the instructions further cause the computer system to download via a data network vehicle inventory information from a dealer inventory computer database associated with an automotive dealership.

35. The computer program product claimed in claim 34, wherein the instructions further cause the computer system to provide a remotely operable user interface via a data network for displaying the determined location of the vehicle.

36. The computer program product claimed in claim 35, wherein the instructions that cause the computer system to provide a user interface cause the computer system to:
display a list of vehicles in dealer inventory;
receive a user selection of a vehicle in the list;
display a graphical map representing the dealer lot; and
display on the graphical map representing the dealer lot a graphical icon representing the location of the vehicle.

37. The computer program product claimed in claim 36, wherein the instructions that cause the computer system to provide a user interface cause the computer system to:
receive a user selection of the graphical icon representing the location of the vehicle; and
in response to the user selection of the graphical icon representing the location of the vehicle, display a graphical callout box in association with the graphical icon, the callout box including a description of vehicle attributes.

38. The computer program product claimed in claim 36, wherein the instructions that cause the computer system to provide a user interface cause the computer system to:
display a textual description of one or more vehicle attributes; and
display an indication of time elapsed since last performing the step of determining the location of the vehicle.

39. The computer program product claimed in claim 35, wherein the instructions that cause the computer system to provide a user interface cause the computer system to:
receive a user selection of one or more vehicle attributes;
search downloaded vehicle inventory information for vehicles in dealer inventory matching the selected attributes;
display on a graphical map representing the dealer lot a graphical icon representing the location of each vehicle in dealer inventory matching the selected attributes.

40. The computer program product claimed in claim 35, wherein the instructions that cause the computer system to receive a user selection of one or more vehicle attributes cause the computer system to:
receive a user selection of one or more vehicle attributes selected from the group: vehicle identification number (VIN), inventory stock number, vehicle manufacturer name, vehicle model name, vehicle series, vehicle year, vehicle color, vehicle status, and vehicle mileage.

41. A method for tracking automotive vehicles in dealer inventory, comprising:
associating each of a plurality of transponder tags with each of a corresponding plurality of vehicles in dealer inventory;
determining a location in the dealer lot of a vehicle with which a transponder tag is associated in response to a radio-frequency (RF) signal received from the transponder tag by a plurality of receivers disposed in a dealer lot;
receiving a key request indication identifying a vehicle for which a corresponding key is requested; and
displaying, in response to the key request, the determined location of the vehicle for which a corresponding key is requested in relation to a graphical representation of the dealer lot.

42. The method claimed in claim 41, further comprising releasing the corresponding key.
